(19) United States
(12) Patent Application Publication
(10) Pub. No.: US 2021/0110348 A1
(43) Pub. Date: Apr. 15, 2021

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Kenji SUZUKI, Kanagawa (JP)

(73) Assignee: FUJI XEROX CO., LTD., Tokyo (JP)

(21) Appl. No.: 16/866,682

(22) Filed: May 5, 2020

(30) Foreign Application Priority Data
Oct. 15, 2019 (JP) 2019-188672

(51) Int. Cl. G06Q 10/10; G06Q 10/06; G06F 16/23

(52) U.S. Cl. CPC G06Q 10/105; G06Q 10/06395; H04N 7/18; G06F 16/2379; G06Q 10/06398

(57) ABSTRACT

An information processing system includes an acquisition section, an output section, and an update section. The acquisition section acquires work information indicating a task or an operation performed by a worker. In response to a determination that the work information does not comply with reference information that defines one or more tasks and/or an order of the one or more tasks, the output section outputs related information that is related to the work information to a specific person. The update section updates the reference information in response to reception of permission information from the specific person that permits the reference information to be updated.

### CROSS-REFERENCE TO RELATED APPLICATIONS

This application is based on and claims priority under 35 USC 119 from Japanese Patent Application No. 2019-188672 filed Oct. 15, 2019.

### BACKGROUND

### (i) Technical Field

The present disclosure relates to an information processing system, an information processing apparatus, and a non-transitory computer readable medium.

### (ii) Related Art

In recent years, a creation apparatus to automatically create a workflow manual has been proposed (for example, refer to Japanese Unexamined Patent Application Publication No. 2006-40160).

A creation apparatus described in Japanese Unexamined Patent Application Publication No. 2006-40160, which is used to create a workflow manual, selects reference data including a workflow and a standard time from a reference database and determines whether an actual work time that is measured is shorter than the standard time. If the actual work time is shorter and the actual workflow has been changed from the workflow in the reference data, the workflow and the work time, which have been changed, are created as new reference data, and the reference data in the reference database is updated.

### SUMMARY

When a workflow manual is updated in accordance with an actual task performed by a worker, a workflow is sometimes changed for the worse.

Aspects of non-limiting embodiments of the present disclosure relate to providing an information processing system, an information processing apparatus, and a non-transitory computer readable medium that can incorporate a task being actually done into a workflow manual while avoiding a change for the worse of the workflow defined in the workflow manual.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including an acquisition section, an output section, and an update section.

The acquisition section acquires work information indicating a task or an operation performed by a worker.

In response to a determination that the work information does not comply with reference information that defines one or more tasks and/or an order of the one or more tasks, the output section outputs related information that is related to the work information to a specific person.

The update section updates the reference information in response to reception of permission information from the specific person that permits the reference information to be updated.

### BRIEF DESCRIPTION OF THE DRAWINGS

Exemplary embodiments of the present disclosure will be described in detail based on the following figures, wherein:

FIG. 1 is an illustration depicting an example configuration of a workflow-manual modification system according to a first exemplary embodiment of the present disclosure;

FIG. 2 is a block diagram depicting an example control system of a server apparatus;

FIG. 3 is an illustration depicting an example feature-value-conversion dictionary;

FIGS. 4A and 4B are illustrations depicting an example operation sequence, FIG. 4A is an illustration depicting operation symbols, which are arranged in an order, and FIG. 4B is a table that provides descriptions of operations represented by the operation symbols used in FIG. 4A;

FIG. 5 is an illustration depicting an example reference sequence;

FIG. 6 is an illustration depicting an example operation-description-conversion dictionary;

FIG. 7 is an illustration depicting example operation sequences and example cyclic operations;

FIG. 8 is a block diagram depicting an example control system of a director terminal;

FIG. 9 is a block diagram depicting an example control system of a worker terminal;

FIG. 10 is a sequence chart depicting an example operation of the workflow-manual modification system;

FIG. 11 is a flowchart depicting an example operation of the server apparatus;

FIG. 12 is an illustration depicting an example configuration of a workflow-manual modification system according to a second exemplary embodiment of the present disclosure;

FIG. 13 is a block diagram depicting an example control system of a director terminal; and

FIG. 14 is a block diagram depicting an example control system of a worker terminal.

### DETAILED DESCRIPTION

Exemplary embodiments of the present disclosure will be described hereinafter with reference to the drawings. In the drawings, elements having substantially identical functions are denoted by the same reference signs, and duplicate descriptions thereof will be omitted. Hereinafter, a workflow-manual modification system that modifies a workflow manual (described below) will be described as an example of an information processing system, but the information processing system is not limited to the workflow-manual modification system.

### Summarization of Exemplary Embodiments

An information processing system according to the present exemplary embodiment includes an acquisition section, an output section, and an update section. The acquisition section acquires work information indicating a task or an operation performed by a worker. In response to a determination that the work information does not comply with reference information that defines one or more tasks and/or an order of the one or more tasks, the output section outputs related information that is related to the work information to a specific person. The update section updates the reference information in response to reception of permission information from the specific person that permits the reference information to be updated.

The reference information refers to information that defines one or more tasks, each of which serves as reference for comparison, or one or more processes, each of which includes a plurality of tasks performed by a worker, and/or a workflow that provides an order of processes. Examples of the reference information include a workflow manual. The term “task” refers to a series of operations performed by a worker. The term “process” refers to a series of tasks performed by a worker. The term “workflow” refers to a plurality of processes defined as a sequence of processes arranged in a predetermined order.

Examples of the work information, which indicates a task, include an operation sequence. An operation sequence is an operation flow in a task constituted by a combination of a plurality of basic operations.

The permission information is information that permits update of the reference information. The term “update” refers to, for example, incorporation of a task indicated by the work information into the reference information. The permission information is generated, for example, in response to approval by a person in charge of the management of the reference information.

### First Exemplary Embodiment

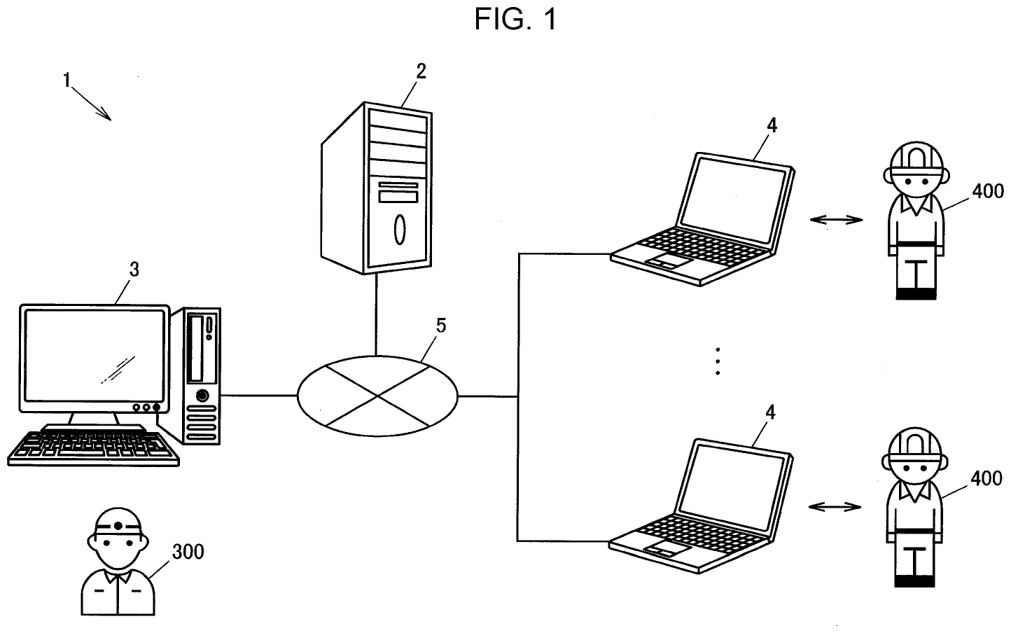

FIG. 1 is an illustration depicting an example configuration of a workflow-manual modification system according to a first exemplary embodiment of the present disclosure. A workflow-manual modification system 1 includes a server apparatus 2, which functions as an information processing apparatus, a terminal apparatus for a director (hereinafter, also referred to as a “director terminal”) 3 connected to the server apparatus 2, and a plurality of terminal apparatuses for workers (hereinafter, also referred to as “worker terminals”) 4 connected to the server apparatus 2. The server apparatus 2, the director terminal 3, and the worker terminals 4 are connected via a network 5 so as to be able to communicate with each other.

A workflow manual defines a plurality of processes that are performed by a plurality of workers 400 in a predetermined order. The workflow manual is an example of the reference information. The term “process” refers to a series of tasks, as a unit, performed by a worker 400. The term “task” refers to a series of operations performed by the worker 400. The term “operation” refers to an individual operation for achieving a task, and an operation includes hand movements and movements of line of sight of the worker 400.

For example, in an assembly process in which products are assembled, the workflow manual defines the following process, which is performed by the worker 400.

Task 1: fasten a unit A to a housing by using screws
Task 2: fasten a unit B to the housing by using screws
Task 3: wire the unit A to the unit B
Task 4: fasten a power unit to the housing and perform wiring
Task 5: attach a cover to the housing
Processes constituted by such tasks are arranged in a specific order. In the following description, the term “workflow” also refers to a series of processes defined as a sequence of processes arranged in a specific order. A work description defined in a workflow manual provides “information that defines one or more tasks, each of which serves as reference for comparison, or one or more processes, and/or an order of tasks and processes”.

Work is defined for each of the tasks 1 to 5. For example, in the case of the task 3, which is one of the tasks 1 to 5 above and is described as “Task 3: wire the unit A to the unit B”, the work is defined as below.

### (A) Briefly Described Task

Example: “wire the unit A to the unit B by using a control cord and a power cord” or the like

### (B) Task Described in Detail by Using Itemized List

Example: “control line wiring: wire the connector X of the unit A to the connector Y of the unit B by using a red cord”
Example: “control line wiring: wire the connector P in the upper part of the unit A to the connector Q on the side of the unit B by using a flat cable” or the like

### (C) Task Described in Specific Detail

Example: “control line wiring: it is advised to pass a flat cable behind the unit C when the connector P in the upper part of the unit A is wired to the connector Q on the side of the unit B by using the flat cable” or the like

As described above, work constituted by a series of operations arranged in a specific order is defined in a “task”.

The workflow manual is not necessarily limited to a document in which work is recorded by using text, figures, and symbols, and may be, for example, a moving image in which actual work is recorded by using a camera, a video camera, or the like, or a voice that describes work or directions and that is recorded by using a microphone or the like. Examples of the server apparatus 2 include a cloud server apparatus.

Examples of the director terminal 3 and the worker terminal 4 include a personal computer, a tablet-type terminal, and a mobile information terminal such as a multifunctional cell phone (smartphone). The director terminal 3 is a terminal apparatus used by a person responsible for the management, such as change or update, of the workflow manual (hereinafter, also referred to as a “person in charge” or a “director”) 300. The person in charge 300 is an example of a specific person. The worker terminal 4 is a terminal apparatus used by the worker 400 who actually performs a task. One or more worker terminals 4 may be used. The worker 400 may wear the worker terminal 4 during work, or the worker terminal 4 may be fixed in a workplace.

In addition, such devices as an acceleration sensor, which measures the movement of a body, and a line of sight detector may be attached to the worker 400, and the information acquired by such sensors and devices may be collected by the worker terminal 4. Furthermore, a moving image of the worker 400 who is working may be captured by a camera, and the moving image information may be acquired by the worker terminal 4.

Examples of the network 5 include a local area network (LAN), a wide area network (WAN), the Internet, and an intranet. The network 5 may be a wired network or a wireless network.

### Configuration of Server Apparatus 2

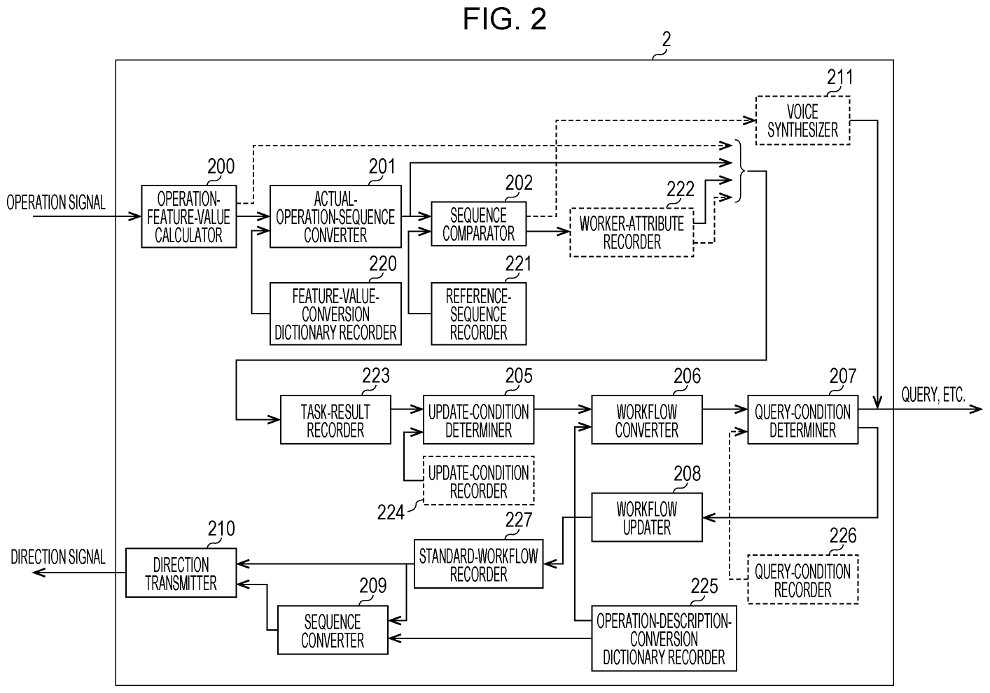

FIG. 2 is a block diagram depicting an example control system of the server apparatus 2. The server apparatus 2 includes operating units and recording units. The operating units include an operation-feature-value calculator 200, an actual-operation-sequence converter 201, a sequence comparator 202, an update-condition determiner 205, a workflow converter 206, a query-condition determiner 207, a workflow updater 208, a sequence converter 209, a direction transmitter 210, and a voice synthesizer 211. The recording units include a feature-value-conversion dictionary recorder 220, a reference-sequence recorder 221, a worker-attribute recorder 222, a task-result recorder 223, an update-condition recorder 224, an operation-description-conversion dictionary recorder 225, a query-condition recorder 226, and a standard-workflow recorder 227.

Arrows in FIG. 2 represent control flows, and, in particular, broken arrows represent control flows relating to update of the workflow manual described below. Some of the recording units 220 to 227 are surrounded by broken lines and also relate to update of the workflow manual described below. Hereinafter, a similar description is sometimes omitted.

The operating units 200 to 211 each include a central processing unit (CPU) and an interface and operate in accordance with a program (not shown). Details of each of the operating units 200 to 211 will be described below. The recording units 220 to 227 each include, for example, a read-only memory (ROM), a random-access memory (RAM), or a hard disk.

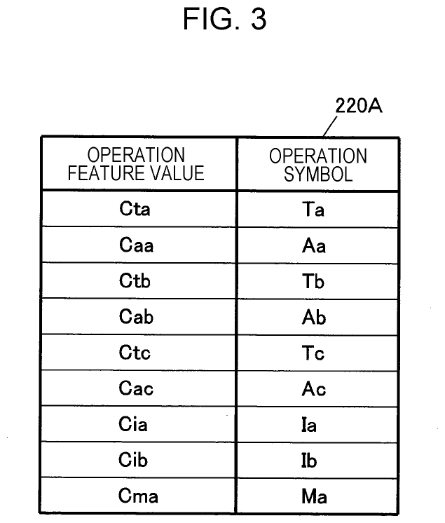

FIG. 3 is an illustration depicting an example feature-value-conversion dictionary. The feature-value-conversion dictionary recorder 220 records a dictionary (hereinafter, also referred to as a “feature-value-conversion dictionary”) 220A that converts a certain quantity indicating a feature of an operation relating to a task (hereinafter, also referred to as an “operation feature value”) into a symbol that identifies the operation (hereinafter, also referred to as an “operation symbol”). As depicted in FIG. 3, the feature-value-conversion dictionary 220A associates an operation feature value with an operation symbol. An operation feature value and an operation symbol are each formed, for example, by using characters such as alphabetic letters in accordance with a predetermined rule. An operation feature value is an example of the work information.

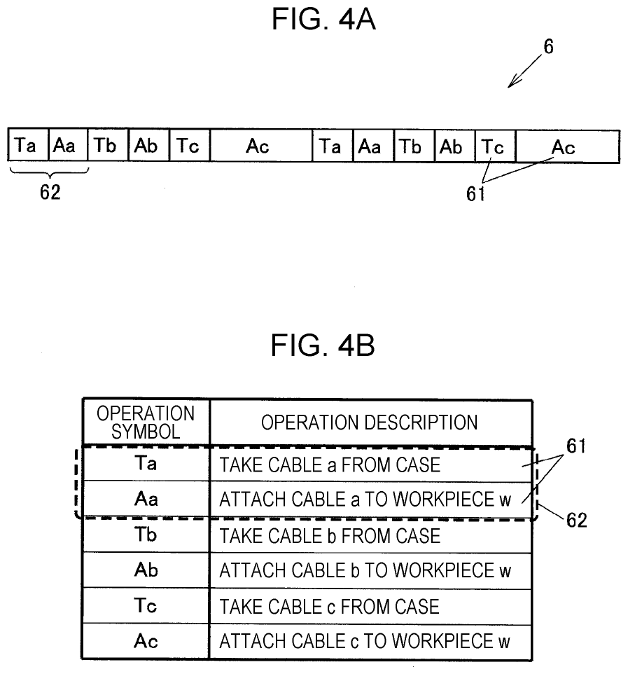

FIGS. 4A and 4B are illustrations depicting an example operation sequence. FIG. 4A is an illustration depicting operation symbols, which are arranged in an order, and FIG. 4B is a table that provides descriptions of operations (hereinafter, also referred to as “operation descriptions”) to which the operation symbols used in FIG. 4A are assigned. An operation sequence 6 is an operation flow that forms a task constituted by a combination of a plurality of operations (hereinafter, also referred to as “basic operations”) each of which provides a basis for the task. A basic operation may be an operation that forms a minimum unit (hereinafter, also referred to as a “minimum operation”) 61 or an operation that is formed by a plurality of minimum operations and that constitutes an element (hereinafter, also referred to as an “elemental operation”) 62.

A minimum operation 61 refers to an operation performed on an object and is represented, for example, by an operation symbol, such as “Tc” or “Ac” in FIGS. 4A and 4B. An elemental operation 62 refers to a combination of a plurality of minimum operations performed on an object. Specifically, an elemental operation 62 refers to a group of minimum operations 61 performed on an object “cable a”, as is surrounded by broken lines in FIG. 4B, and more specifically, refers to an operation formed by an operation “take a cable a from a case” (represented by an operation symbol “Ta”) and an operation “attach a cable a to a workpiece w” (represented by an operation symbol “Aa”).

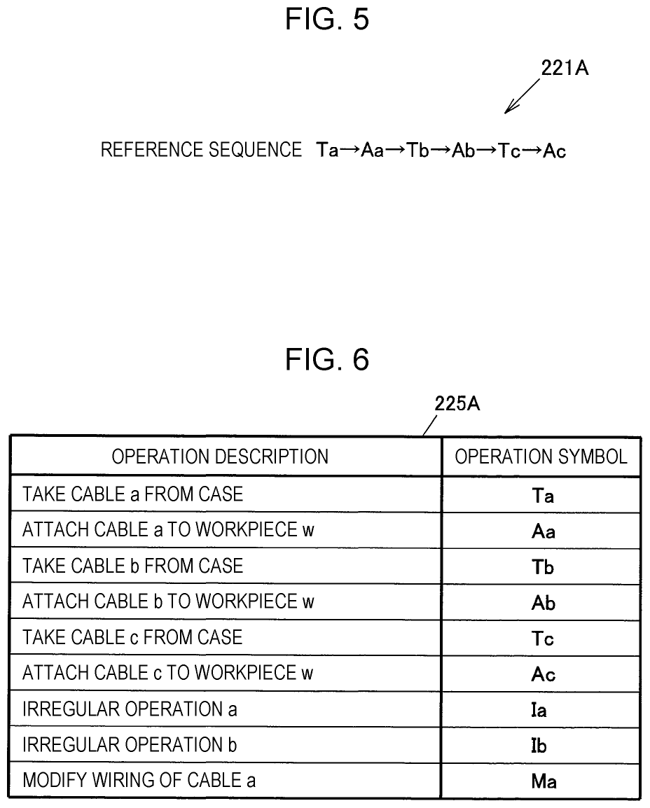

FIG. 5 is an illustration depicting an example reference sequence. The reference-sequence recorder 221 records a reference sequence 221A, which is a reference to be compared with an actual operation sequence that is a series of operations actually performed by the worker 400.

The reference sequence 221A is defined in the workflow manual. As depicted in FIG. 5, the reference sequence 221A is formed by arranging operation symbols such as “Ta” and “Aa” described above.

The worker-attribute recorder 222 records attribute information that represents an attribute of the worker 400. Attribute information recorded in the worker-attribute recorder 222 includes mainly an index that indicates the degree of skill of the worker 400 in performing a task. For example, evaluation values such as work experience and skill levels that indicate whether the worker 400 is an expert or a novice are used as the “index that indicates the degree of skill in performing a task”. Attribute information is an example of related information.

The task-result recorder 223 records a result of determination with respect to the difference between an actual operation sequence and a reference sequence (hereinafter, also referred to as a “determination result” or a “task result”). A task result is an example of the related information. The update-condition recorder 224 records a condition to determine whether the actual operation sequence is a candidate to be incorporated into the workflow manual, in other words, whether the actual operation sequence is a candidate by which the workflow manual is to be updated (hereinafter, also referred to as an “update condition”).

The following examples each represent an update condition.

### (A) Average of and Variation in Task Durations

When the actual operation sequence is repeated a certain times or more, the average of durations required to perform the task (hereinafter, also referred to as an “average task duration”) or the variation in task durations is equal to or less than respective predetermined values.

### (B) Repetition Frequency

When the actual operation sequence is repeated a certain times or more, the frequency of repetition is equal to or more than a predetermined value.

### (C) Appropriateness Determination Basis

Several items (hereinafter, also referred to as a “determination basis”) to determine the index to indicate whether incorporating the actual operation sequence into the workflow manual is appropriate (hereinafter, the index is also referred to as “appropriateness”) each satisfy predetermined requirements.

For example, the appropriateness determination basis described in (C) above includes the following items.

(a) Attribute information of the worker 400
(b) Information regarding operations in a task
(c) Information regarding product quality
(d) Information regarding tools used during a task
(e) Information regarding raw materials
(f) Information regarding instruments used during a task and the like
The appropriateness determination basis is an example of the related information. The information regarding product quality is an example of quality information.

In Table 1 below, specific examples of (a) to (f) described above are listed.

TABLE 1
Specific Examples of Appropriateness Determination Basis

| Item | | Description | Specific Examples |
|---|---|---|---|
| (a) | Attribute information | Information representing an | Skill level |
| | of the worker 400 | attribute of the worker 400 | Work experience, etc. |
| (b) | Information regarding | A feature value calculated based | Work load |
| | operations in a task | on a posture during a task | Moving distance (body, |
| | | | hand, gazing point, etc.), etc. |
| | | A feature value calculated based on | Muscle activity |
| | | data obtained from a biometric | Heartbeat |
| | | sensor or an acceleration sensor | Pulsation |
| | | | Breath, etc. |
| (c) | Information regarding | Data that is generated after a task | Inspection data of |
| | product quality | and that indicates an inspection | products and components |
| | | result of products and components. | after assembly |
| | | In particular, the quality provided by | Processing accuracy |
| | | executing a task whose | data of components |
| | | incorporation into the workflow | after processing, etc. |
| | | manual is to be determined*. | |
| (d) | Information regarding tools | A feature value obtained from | Whether an electric |
| | used during a task | a sensor attached to a tool | screwdriver is set at a |
| | | | correct angle with |
| | | | respect to a workpiece |
| | | | A wearing speed of a blade, etc. |
| (e) | Information regarding | The amount of a | The amount of a consumed adhesive |
| | raw materials | consumed raw material | The amount of power usage, etc. |
| (f) | Information regarding | A feature value obtained from a | Power consumption |
| | instruments used during a task | sensor attached to an instrument | Operating time |
| | | | Vibration, etc. |

*A task whose incorporation into the workflow manual is to be determined is an example of a “task indicated by the work information”.

FIG. 6 is an illustration depicting an example operation-description-conversion dictionary. The operation-description-conversion dictionary recorder 225 records a dictionary 225A that converts an operation description into an operation symbol. As depicted in FIG. 6, the operation-description-conversion dictionary 225A associates an operation description with an operation symbol.

The query-condition recorder 226 records a condition to determine whether to ask the person in charge 300 whether a task, which is performed by the worker 400 and satisfies at least one of the update conditions described above, is to be incorporated into the workflow manual (hereinafter, the condition is also referred to as a “query condition”).

The following examples each represent a query condition.

Condition 1: A performed task satisfies an update condition.
Condition 2: A performed task satisfies an update condition, and incorporating the task reduces a task duration.
Condition 3: A performed task satisfies an update condition, incorporating the task reduces a task duration, and the task has been performed by the worker 400 who has a predetermined skill level.

If an actual operation sequence does not differ from the reference sequence, the standard-workflow recorder 227 records the actual operation sequence as a standard task.

The operation-feature-value calculator 200 receives a signal that is output from the worker terminal 4 and that relates to one or more operations of the worker 400 (hereinafter, also referred to as an “operation signal”) and analyzes the received signal to calculate one or more operation feature values included in the operation signal. Specifically, the operation-feature-value calculator 200 calculates data in which operation feature values are arranged in a chronological order. A method to calculate one or more operation feature values by using an operation signal is not particularly limited as long as one or more operation features are obtained from an operation signal. For example, a device such as a converter that has undergone in advance machine learning such as deep learning may be used. The operation-feature-value calculator 200 is an example of an acquisition section.

The actual-operation-sequence converter 201 uses the feature-value-conversion dictionary 220A (see FIG. 3) recorded in the feature-value-conversion dictionary recorder 220 and converts into the operation sequence 6 operation feature values that are calculated by the operation-feature-value calculator 200 and that are arranged in a chronological order. In addition, the actual-operation-sequence converter 201 extracts an operation pattern that repeatedly appears in the operation sequence 6 (hereinafter, also referred to as a “cyclic operation”) and measures a period that a cyclic operation takes. A period that a cyclic operation takes is an example of the related information.

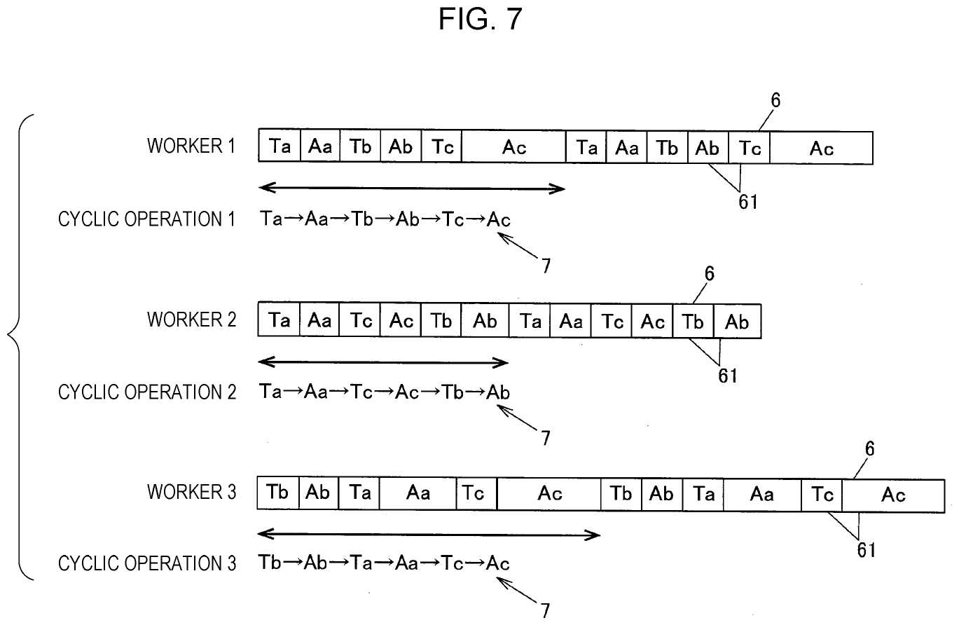

FIG. 7 is an illustration depicting examples of the operation sequence 6 and the cyclic operation. FIG. 7 illustrates operation sequences 6 and cyclic operations (cyclic operations 1 to 3) performed by three workers, the workers 1 to 3. As depicted in FIG. 7, the actual-operation-sequence converter 201 converts operation feature values that are calculated by the operation-feature-value calculator 200 and that are arranged in a chronological order into the operation sequence 6 depicted by using an arrangement of operation symbols.

Next, the actual-operation-sequence converter 201 extracts an operation pattern (refer to a double-pointed arrow) from the operation sequence 6 as a cyclic operation 7. In addition, the actual-operation-sequence converter 201 measures a period that the cyclic operation 7, which is extracted, takes.

The sequence comparator 202 compares an actual operation sequence and the reference sequence 221A recorded in the reference-sequence recorder 221 and determines the difference between the actual operation sequence and the reference sequence 221A.

If a repetition of a specific basic-operation cycle constitutes an actual operation sequence, the sequence comparator 202 determines the difference in a single cycle as an example. The sequence comparator 202 also sends a task result, which is a result obtained by the determination, to the task-result recorder 223. The task-result recorder 223 records the task result that is sent.

If an actual operation sequence differs from the reference sequence 221A, the update-condition determiner 205 determines whether the actual operation sequence satisfies at least one of the update conditions described above.

The workflow converter 206 converts an actual operation sequence that satisfies at least one of the update conditions into a form used in a query in a natural language or the like. The query-condition determiner 207 determines whether a query is to be sent to the person in charge 300 in accordance with the query conditions described above. In addition, if it is determined that a query is to be sent to the person in charge 300, the query-condition determiner 207 transmits information containing the query content to the director terminal 3.

Further, the query-condition determiner 207 transmits to the director terminal 3 an operation period of one cycle sent from the actual-operation-sequence converter 201, a determination result that provides the difference between the sequences sent from the sequence comparator 202, and an appropriateness determination basis, together with the information containing the query content. The query-condition determiner 207 is an example of an output section.

The workflow updater 208 updates the workflow manual if permission to update the workflow manual is obtained from the person in charge 300. Specifically, the actual operation sequence is incorporated into the workflow manual. The workflow updater 208 is an example of an update section.

The sequence converter 209 uses the operation-description-conversion dictionary 225A (see FIG. 6) and converts operation descriptions into an operation symbol sequence. At a fixed time point, the direction transmitter 210 transmits to the worker terminal 4 operation descriptions and an operation symbol sequence as a direction to update the workflow manual (hereinafter, also referred to as an “update direction”).

If an actual operation sequence differs from the reference sequence 221A, that is, the worker 400 performs a task that differs from the reference sequence 221A, the voice synthesizer 211 creates a question formed by using a synthesized voice to check with the worker 400 the reason that the task has been performed. In addition, the voice synthesizer 211 transmits the synthesized voice relating to the question to the worker terminal 4. The voice synthesizer 211 is an example of a check section.

### Configuration of Director Terminal 3

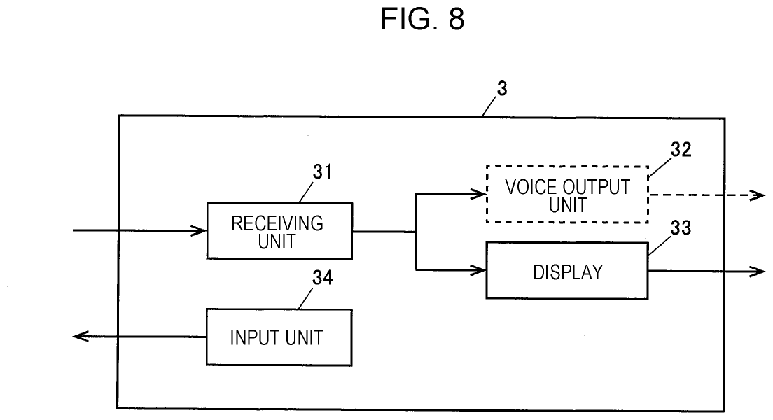

FIG. 8 is a block diagram depicting an example control system of the director terminal 3. As depicted in FIG. 8, the director terminal 3 includes a receiving unit 31 that receives information and a signal transmitted from an external apparatus, a voice output unit 32 that outputs a voice, a display 33 that displays various kinds of information, and an input unit 34 that inputs various kinds of information into the server apparatus 2.

For example, the receiving unit 31 receives information containing query content transmitted from the query-condition determiner 207 of the server apparatus 2. In addition, the receiving unit 31 delivers the received information to the voice output unit 32 or the display 33.

The voice output unit 32 outputs a voice describing a query in accordance with the information delivered by the receiving unit 31 and induces the person in charge 300 to determine whether the task constituted by the actual operation sequence is incorporated into the workflow manual. The display 33 displays text and figures describing the query in accordance with the information delivered by the receiving unit 31 and induces the person in charge 300 to determine whether the task constituted by the actual operation sequence is incorporated into the workflow manual. The task constituted by the actual operation sequence is an example of a task indicated by the work information.

The mode in which a query is made is not limited to only one of a voice output by using the voice output unit 32 and presentation by using the display 33, and both of a voice output by using the voice output unit 32 and presentation by using the display 33 may be adopted. In addition, the query method is not limited to presentation by using voice, text, figures, and the like, and, for example, transmission of an email or a message to the person in charge 300 may be adopted.

The input unit 34 inputs various kinds of information to be recorded in the recording units 220 to 227 of various kinds, which are disposed in the server apparatus 2 and described above. In particular, the input unit 34 inputs permission information that permits the task constituted by the actual operation sequence to be included in the workflow manual and that thereby permits the workflow manual to be updated. Examples of the permission information include approval provided by the person in charge 300 for the difference between an actual operation sequence and the reference sequence 221A. The input unit 34 is constituted, for example, by a keyboard, a mouse, and the like.

### Configuration of Worker Terminal 4

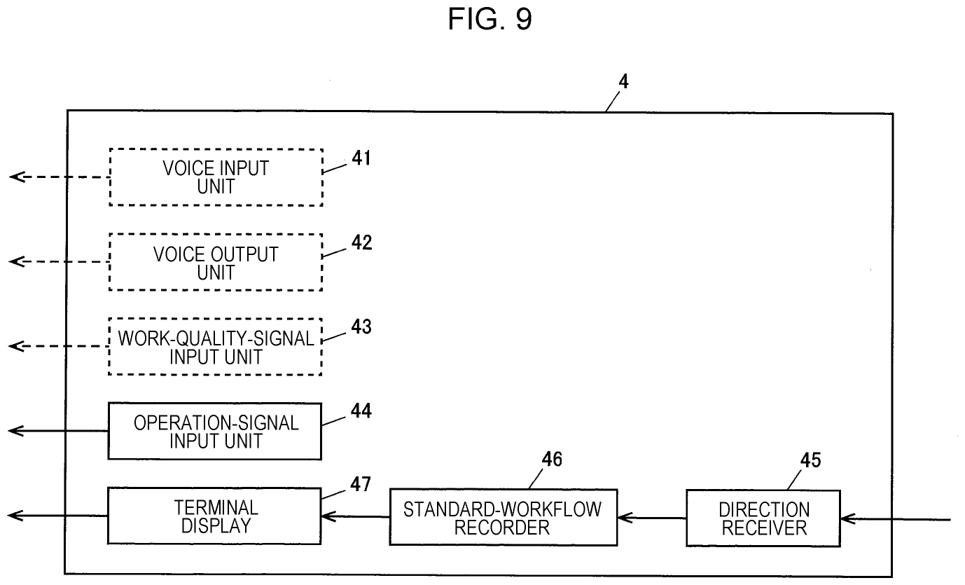

FIG. 9 is a block diagram depicting an example control system of the worker terminal 4. As depicted in FIG. 9, the worker terminal 4 includes a voice input unit 41, a voice output unit 42, a work-quality-signal input unit 43, an operation-signal input unit 44, a direction receiver 45, a standard-workflow recorder 46, and a terminal display 47. The voice input unit 41 detects a voice of the worker 400 and transmits and inputs the content of the voice to the server apparatus 2. The voice output unit 42 outputs a voice to the worker 400. The work-quality-signal input unit 43 inputs to the server apparatus 2 a signal including information regarding product quality. The operation-signal input unit 44 detects an operation signal and transmits and inputs information regarding an operation to the server apparatus 2. The direction receiver 45 receives a direction sent from an external apparatus such as the server apparatus 2. The standard-workflow recorder 46 records tasks and/or a workflow defined in the workflow manual (hereinafter, also referred to as a “standard workflow”). The terminal display 47 presents various kinds of information.

For example, the voice input unit 41 inputs as voice information a reply made by the worker 400 to respond to a question addressed to inquire a reason to the worker 400 who has performed a task or a workflow that does not comply with the workflow manual. The reply includes a reason that a task or a workflow that does not comply with the workflow manual has been performed.

The voice output unit 42 outputs in a voice the question addressed to inquire a reason to the worker 400 who has performed a task or a workflow that does not comply with the workflow manual. In this case, the query-condition determiner 207 of the server apparatus 2 transmits to the director terminal 3 the information containing the reason, which has been input into the server apparatus 2 by using the voice input unit 41, together with the information containing the query content and a few pieces of related information described above.

The operation-signal input unit 44 includes, for example, the following components.

### (a) Camera

A camera as an attachment to smart glasses that the worker 400 wears
A camera fixed at a specific position, etc.
   A camera is an example of an image capture section.

### (b) Microphone

A microphone to pick up a voice of the worker 400, etc.

### (c) Acceleration Sensor

An acceleration sensor carried by the worker 400 during work to measure the movement of the worker 400 during work

### (d) Sensor

A sensor disposed in a component box (not shown) or the like on a workbench (not shown) to capture the movement of hands of the worker 400 during work, etc.
   A sensor is an example of a detecting section.

### (e) Others

A start button and the like of various instruments operated by the worker 400 during work

### Operation in First Exemplary Embodiment

### (1) Operation of Workflow-Manual Modification System 1

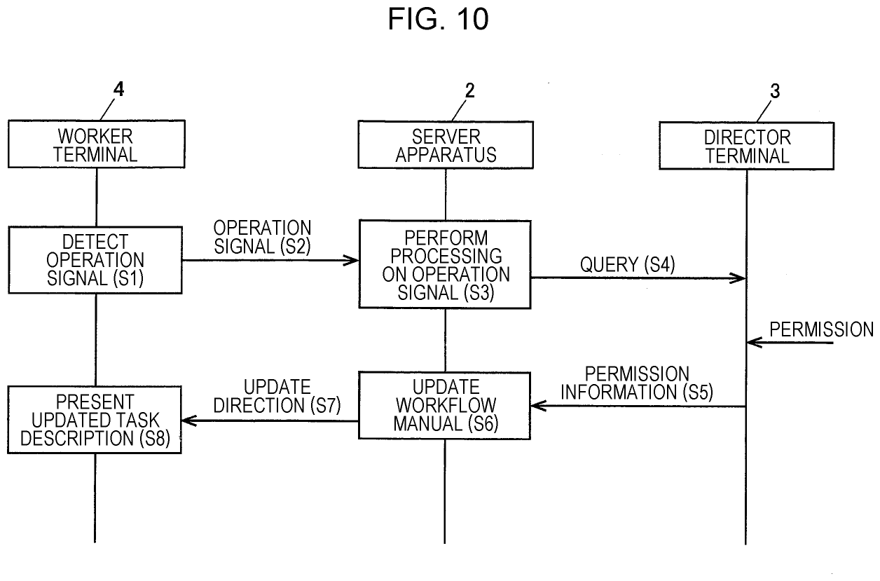

Next, an example operation of the workflow-manual modification system 1 will be described with reference to FIG. 10. FIG. 10 is a sequence chart depicting an example operation of the workflow-manual modification system 1 according to the first exemplary embodiment. As depicted in FIG. 10, the operation-signal input unit 44 of the worker terminal 4 detects an operation signal (S1) and transmits the operation signal to the server apparatus 2 (S2).

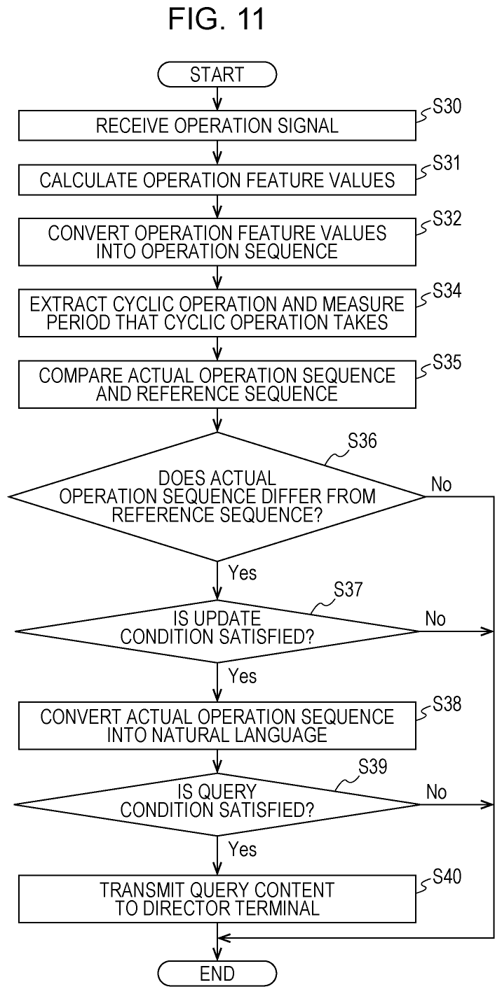

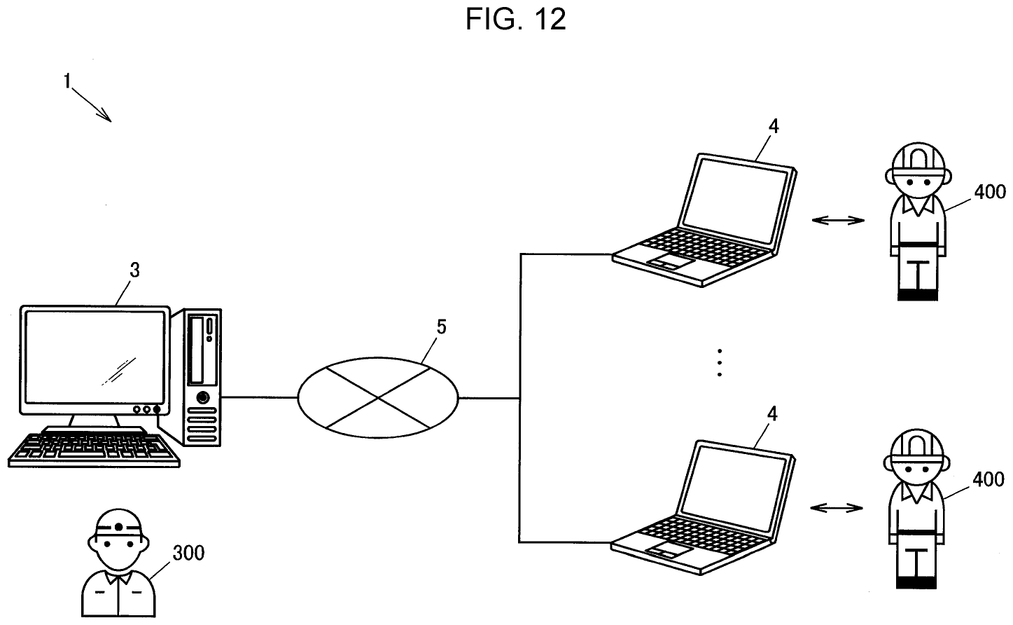

The server apparatus 2 receives the operation signal and performs processing on the received operation signal (S3). Details of the processing on the operation signal will be described below (refer to FIG. 11). The query-condition determiner 207 of the server apparatus 2 makes a query to the director terminal 3 (S4). Specifically, the query-condition determiner 207 transmits to the director terminal 3 the information containing the query content and the related information such as an operation period of one cycle, a determination result, and an appropriateness determination basis.

The receiving unit 31 of the director terminal 3 receives the information containing the query content described above. The receiving unit 31 delivers the received information to the voice output unit 32 or the display 33. The voice output unit 32 or the display 33 outputs or presents the query content to the person in charge 300.

If the person in charge 300 inputs permission to update the workflow manual via the director terminal 3, the input unit 34 transmits to the server apparatus 2 permission information indicating that update of the workflow manual is permitted (S5). In response to reception of the permission information by the server apparatus 2, the workflow updater 208 updates the workflow manual (S6).

Next, at a fixed time point, the direction transmitter 210 transmits to the worker terminal 4 operation descriptions and an operation symbol sequence as an update direction (S7).

The direction receiver 45 of the worker terminal 4 receives the update direction. In the worker terminal 4, the workflow recorded in the standard-workflow recorder 46 is updated in accordance with the received update direction. In addition, the terminal display 47 presents an updated task description to the worker 400 (S8) and guides the worker 400 in performing the task.

### (2) Operation of Server Apparatus 2

FIG. 11 is a flowchart depicting an example operation of the server apparatus 2. As depicted in FIG. 11, if the server apparatus 2 receives an operation signal transmitted from the worker terminal 4 (S30), the operation-feature-value calculator 200 analyzes the operation signal and calculates operation feature values (S31).

Next, the actual-operation-sequence converter 201 converts the operation feature values into the operation sequence 6 (refer to FIG. 7) (S32). In addition, the actual-operation-sequence converter 201 extracts a cyclic operation from the operation sequence 6 and measures a period that a cyclic operation takes (S34).

Then, the sequence comparator 202 compares an actual operation sequence and the reference sequence 221A (refer to FIG. 5) recorded in the reference-sequence recorder 221 (S35). If the actual operation sequence differs from the reference sequence 221A (Yes in S36), the update-condition determiner 205 determines whether the actual operation sequence satisfies an update condition (S37).

If the actual operation sequence satisfies an update condition (Yes in S37), the workflow converter 206 converts the actual operation sequence that satisfies the update condition into a form in a natural language (S38). Subsequently, the query-condition determiner 207 determines whether a query is to be sent to the person in charge 300 in accordance with query conditions (S39).

If one of the query conditions is satisfied (Yes in S39), the query-condition determiner 207 transmits information containing the query content to the director terminal 3 (S40). At this time, in addition to the information containing the query content, the query-condition determiner 207 transmits to the director terminal 3 the related information such as an operation period of one cycle, a determination result, and an appropriateness determination basis.

### Second Exemplary Embodiment

FIG. 12 is an illustration depicting an example configuration of a workflow-manual modification system 1 according to a second exemplary embodiment of the present disclosure. Some of the operating units 200 to 211 and some of the recording units 220 to 227 disposed in the server apparatus 2 may be moved to the director terminal 3 or the worker terminal 4. Further, for example, as depicted in FIG. 12, the workflow-manual modification system 1 may be constructed without the server apparatus 2.

Hereinafter, as the second exemplary embodiment, an example configuration of the workflow-manual modification system 1 constructed without the server apparatus 2 will be described. Descriptions focus on features that differ from the features of the first exemplary embodiment. Elements having functions substantially identical to the elements described in the first exemplary embodiment are denoted by the same reference signs, and detailed descriptions thereof will be omitted.

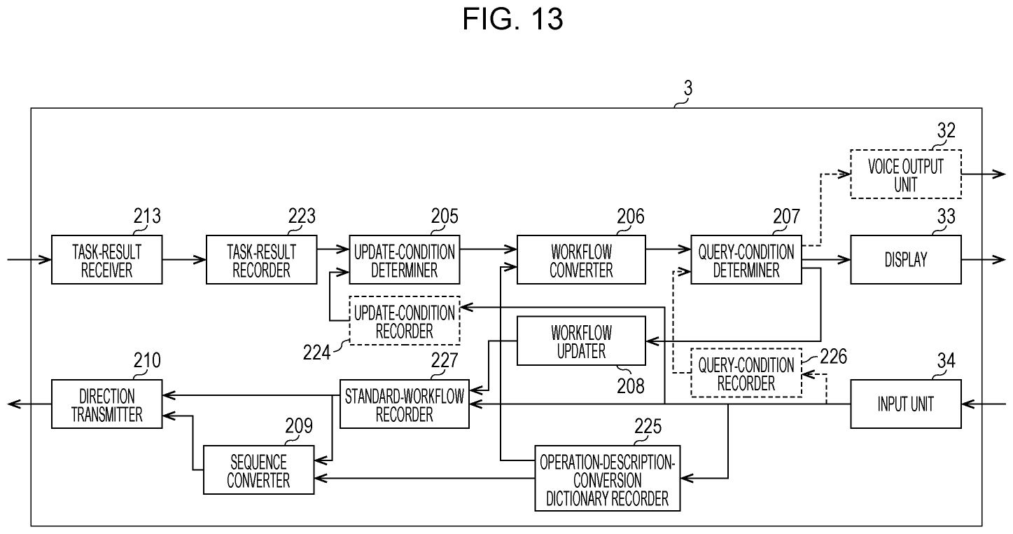

FIG. 13 is a block diagram depicting an example control system of the director terminal 3 depicted in FIG. 12. As depicted in FIG. 13, for example, the update-condition determiner 205, the workflow converter 206, the query-condition determiner 207, the workflow updater 208, the sequence converter 209, the direction transmitter 210, the task-result recorder 223, the update-condition recorder 224, the operation-description-conversion dictionary recorder 225, the query-condition recorder 226, and the standard-workflow recorder 227, which are disposed in the server apparatus 2 in the first exemplary embodiment, may be disposed in the director terminal 3.

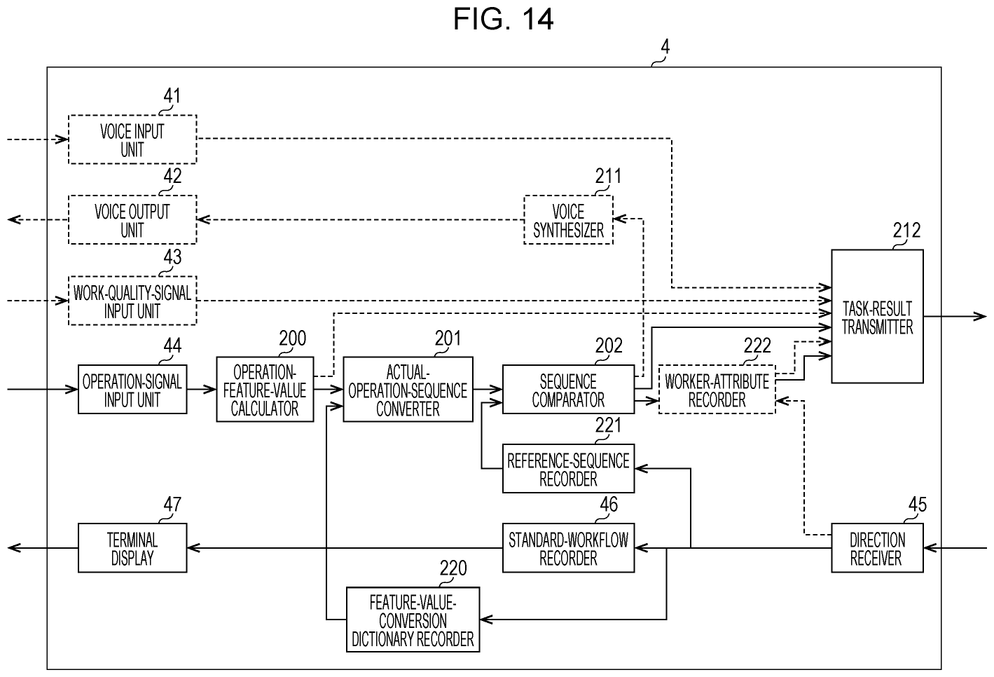

FIG. 14 is a block diagram depicting an example control system of the worker terminal 4 depicted in FIG. 12. As depicted in FIG. 14, for example, the operation-feature-value calculator 200, the actual-operation-sequence converter 201, the sequence comparator 202, the voice synthesizer 211, the feature-value-conversion dictionary recorder 220, the reference-sequence recorder 221, and the worker-attribute recorder 222, which are disposed in the server apparatus 2 in the first exemplary embodiment, may be disposed in the worker terminal 4. In other words, the worker terminal 4 may have a function of analyzing an operation signal of the worker 400.

In the configuration example depicted in FIG. 12, the worker terminal 4 further includes a task-result transmitter 212 that transmits a task result obtained by analysis to the director terminal 3, and the director terminal 3 further includes a task-result receiver 213 (refer to FIG. 13) that receives the task result transmitted from the task-result transmitter 212.

### Operation in Second Exemplary Embodiment

In the worker terminal 4, The operation-signal input unit 44 receives an operation signal and inputs the operation signal into the operation-feature-value calculator 200. The operation-feature-value calculator 200 analyzes the operation signal and calculates operation feature values arranged in a chronological order.

Next, the actual-operation-sequence converter 201 converts the operation feature values arranged in a chronological order into the operation sequence 6 depicted in FIG. 7, measures an operation period of one cycle extracted from the operation sequence 6, and transmits the operation period of one cycle to the task-result transmitter 212.

Then, the sequence comparator 202 compares an actual operation sequence that represents operations by the worker 400 and the reference sequence 221A (refer to FIG. 5), which is recorded in advance, and sends to the task-result transmitter 212 a determination result provided based on the difference between the sequences.

Subsequently, the task-result transmitter 212 transmits to the director terminal 3 the operation period of one cycle, which is sent from the actual-operation-sequence converter 201, the determination result provided based on the difference between the sequences, which is sent from the sequence comparator 202, and an appropriateness determination basis.

In the director terminal 3, the task-result receiver 213 receives the operation period of one cycle, the determination result, and the appropriateness determination basis, which are transmitted from the worker terminal 4. In the director terminal 3, the update-condition determiner 205 determines whether an update condition is satisfied, the workflow converter 206 converts the actual operation sequence to a form in a natural language, and the query-condition determiner 207 determines whether a query condition is satisfied.

If a query condition is satisfied, the voice output unit 32 or the display 33 outputs or presents the query content to the person in charge 300.

The exemplary embodiments according to the present disclosure have been described as above, but the exemplary embodiments according to the present disclosure are not limited to the exemplary embodiments described above. Various modifications and practices are possible without departing from the spirit of the present disclosure. For example, a setting section may further be included to set in advance or after the update of a workflow manual a range in which an updated workflow manual applies. Specifically, the update may apply to the workers 400 in a certain plant or to all the workers 400. The setting section may be disposed, for example, in the server apparatus 2 or in the director terminal 3.

Further, for example, the director terminal 3 may be configured to induce the person in charge 300 to ask the worker 400 a question, so that the person in charge 300 directly asks the worker 400 the question via a voice line or the like. In addition, if the difference between operations or tasks is within each predetermined limit, the workflow manual may be allowed to be automatically updated with respect to the operations or the tasks without approval by the person in charge 300.

A portion or all of each of the operating units 200 to 213, which are disposed in the server apparatus 2, the director terminal 3, or the worker terminal 4, may be constituted by a hardware circuit, such as a field programmable gate array (FPGA) or an application specific integrated circuit (ASIC).

Further, some of the elements of the exemplary embodiments described above may be removed or modified without departing from the spirit of the present disclosure. Further, addition, removal, modification, exchange, and the like of the steps in the flow in the exemplary embodiments described above are possible without departing from the spirit of the present disclosure. The programs used in the exemplary embodiments described above may be recorded in a computer-readable recording medium, such as a compact-disc ROM (CD-ROM), and provided.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
an acquisition section that acquires work information indicating a task or an operation performed by a worker;
an output section that, in response to a determination that the work information does not comply with reference information that defines one or more tasks and/or an order of the one or more tasks, outputs related information that is related to the work information to a specific person; and
an update section that updates the reference information in response to reception of permission information from the specific person that permits the reference information to be updated.

2. The information processing system according to claim 1,
wherein the output section outputs the related information in response to a frequency of repetition of the task being equal to or larger than a predetermined value, the task being indicated by the work information that has been acquired.

3. The information processing system according to claim 1,
wherein the output section extracts a difference between the work information and the reference information as the related information to output to the specific person.

4. The information processing system according to claim 2,
wherein the output section extracts a difference between the work information and the reference information as the related information to output to the specific person.

5. The information processing system according to claim 3,
wherein the permission information includes (i) an approval of the update and (ii) update information to update the reference information, and
wherein the approval is obtained based on the difference output as the related information.

6. The information processing system according to claim 4,
wherein the permission information includes (i) an approval of the update and (ii) update information to update the reference information, and
wherein the approval is obtained based on the difference output as the related information.

7. The information processing system according to claim 5, further comprising:
a setting section that at the approval of the update, adds to the update information a range in which the updated reference information applies.

8. The information processing system according to claim 6, further comprising:
a setting section that at the approval of the update, adds to the update information a range in which the updated reference information applies.

9. The information processing system according to claim 5,
wherein the update section updates the reference information in accordance with the work information without the approval of the update if the task or the operation indicated by the work information that has been acquired is within each predetermined limit.

10. The information processing system according to claim 6,
wherein the update section updates the reference information in accordance with the work information without the approval of the update if the task or the operation indicated by the work information that has been acquired is within each predetermined limit.

11. The information processing system according to claim 7,
wherein the update section updates the reference information in accordance with the work information without the approval of the update if the task or the operation indicated by the work information that has been acquired is within each predetermined limit.

12. The information processing system according to claim 8,
wherein the update section updates the reference information in accordance with the work information without the approval of the update if the task or the operation indicated by the work information that has been acquired is within each predetermined limit.

13. The information processing system according to claim 1,
wherein the output section further outputs, as the related information, quality information that indicates product quality delivered by performing the task indicated by the work information.

14. The information processing system according to claim 2,
wherein the output section further outputs, as the related information, quality information that indicates product quality delivered by performing the task indicated by the work information.

15. The information processing system according to claim 1,
wherein the output section further outputs, as the related information, attribute information that indicates an attribute of the worker who has performed the task indicated by the work information.

16. The information processing system according to claim 1, further comprising:
a check section that checks with the worker who has performed the task indicated by the work information a reason that the task has been performed,
wherein the output section further outputs as the related information the reason that has been checked.

17. The information processing system according to claim 1, further comprising:
an image capture section that captures a movement of the worker,
wherein the acquisition section acquires the work information in accordance with information acquired by the image capture section.

18. The information processing system according to claim 1, further comprising:
a detecting section that is attached to the worker and that detects a movement of the worker,
wherein the acquisition section acquires the work information in accordance with information acquired by the detecting section.

19. A non-transitory computer readable medium storing a program causing a computer to execute a process for information processing, the process comprising:
acquiring work information indicating a task or an operation performed by a worker;
in response to a determination that the work information does not comply with reference information that defines one or more tasks and/or an order of the one or more tasks, outputting related information that is related to the work information; and
updating the reference information in response to reception of permission information that permits the reference information to be updated.

20. An information processing apparatus comprising:
an acquisition section that acquires work information indicating a task or an operation performed by a worker;
an output section that, in response to a determination that the work information does not comply with reference information that defines one or more tasks and/or an order of the one or more tasks, outputs related information that is related to the work information; and
an update section that updates the reference information in response to reception of permission information that permits the reference information to be updated.
